(19) United States
(12) Patent Application Publication
(10) Pub. No.: US 2014/0028630 A1
(43) Pub. Date: Jan. 30, 2014

(54) LIGHT GUIDE PLATE TOUCH DEVICE

(71) Applicant: Era Optoelectronics Inc., New Taipei City (TW)

(72) Inventor: CHIH-HSIUNG LIN, New Taipei City (TW)

(73) Assignee: Era Optoelectronics Inc., New Taipei City (TW)

(21) Appl. No.: 13/949,514

(22) Filed: Jul. 24, 2013

(30) Foreign Application Priority Data
Jul. 27, 2012 (TW) 101127368

(51) Int. Cl. G06F 3/042

(52) U.S. Cl. CPC G06F 3/0428
USPC 345/175

(57) ABSTRACT

A light guide plate touch device comprises a light guide plate, multiple photosensors, at least two light sources, and a microprocessors; the cheap photosensors are utilized to surround the lower surface or the periphery of the light guide plate to form an operation zone; the microprocessor figures out position information of the touch point and outputs a corresponding touch signal according to the following: confirming the photosensors have sensed the distorted modulating signals, position information of the at least two light sources, and position information of two of the photosensors corresponding to the two lights and sensing the distorted modulating signals; since there is no need for a capacitive induction layer precisely adhered to the lower surface of the light guide plate or metal connecting device, the structure is simplified, and the cost is lowered so as to enhance production yields.

### CROSS-REFERENCE TO RELATED APPLICATIONS

The application claims priority from Taiwan Patent Application No. 101127368 filed on Jul. 27, 2012, the disclosure of which is incorporated herein by reference.

### BACKGROUND OF THE INVENTION

1. Field of the Invention

The present invention relates to a touch device, and, more particularly, to a touch device which detects the state of lights guided by the guide light plate and generates corresponding control signals.

2. Description of Related Art

Currently, there are many touch devices made with glass. For instance, Taiwan Utility Model No. M432884 discloses a capacitive touch panel consisting of an induction substrate, a capacitive induction layer and a signal circuit board. The upper layer surface of the induction substrate is capable of being touched by the user for operation of control; the capacitive induction layer is disposed at the lower layer surface with an electrode zone having several X-coordinate and Y-coordinate electrodes along horizontal and vertical directions, respectively; the X-coordinate electrodes and Y-coordinate electrodes are cross-connected to each other respectively, and insulations are provided at possible contact spots to space out the X-coordinate electrodes from Y-coordinate electrodes; the signal circuit board is secured to the induction substrate; the X-coordinate and Y-coordinate electrodes are connected to the signal circuit board, respectively.

Taiwan Utility Model No. M371271 discloses a thin touch panel which has a transparent substrate with the inner surface thereof forming a shield layer at the periphery and being disposed with a metal connecting structure, a metal guide path, a transparent insulator and a sensing layer such that the transparent substrate is not only a touch end but also provided with control capability of the thin touch panel directly.

The touch devices taught in the preceding prior art references have to be adhered precisely with the capacitive induction layer or the metal connecting structure at the lower surface of the respective glass plate. Otherwise, the contact spots are impossible to be detected exactly, and the touch signals are incapable of being output correctly.

### SUMMARY OF THE INVENTION

In order to improve the conventional glass touch device, the present invention is proposed.

The primary object of the present invention is to provide a light guide plate touch device which comprises a light guide plate, multiple photosensors, at least two light sources, and a microprocessor, wherein the photosensors surround a region at the lower surface or the periphery of the light guide plate to form an operation zone; the microprocessor figures out position information of a touch point and outputs a corresponding touch signal according to the following: the microprocessor confirms that the modulating signals sensed by the photosensors are distorted modulating signals; position information of the two light sources; and position information of at least two of the photosensors which correspond to at least two lights containing the modulating signals emitting from the two light sources and sense the distorted modulating signals.

Another objective of the present invention is to provide a light guide plate touch device with which an effect of sensing the touch point can be achieved by using cheap photosensors that surround a region of the lower surface or the periphery of the light guide plate instead of the lower surface of the light guide plate being precisely adhered with the capacitive induction layer or metal connecting structure. As such, a touch device with simple and low cost structure can be obtained to enhance production yields.

Further benefits and advantages of the present invention will become apparent after a careful reading of the detailed description with appropriate reference to the accompanying drawings.

### BRIEF DESCRIPTION OF THE DRAWINGS

FIG. 1 is a top view of the first embodiment of a light guide plate touch device according to the present invention;

FIG. 2 is a plan view illustrating an object contacting the light guide plate touch device of the first embodiment;

FIG. 3 is a graph showing intensities of modulating signals with respect to a photosensor array according to the present invention;

FIG. 4 is a bottom view of the second embodiment of a light guide plate touch device according to the present invention;

FIG. 5 is a plan view illustrating an object contacting the light guide plate touch device of the second embodiment.

### DETAILED DESCRIPTION OF THE INVENTION

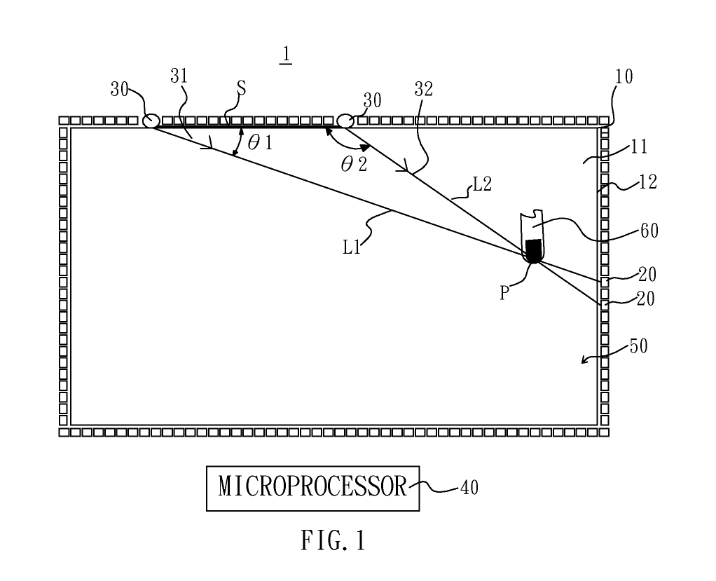

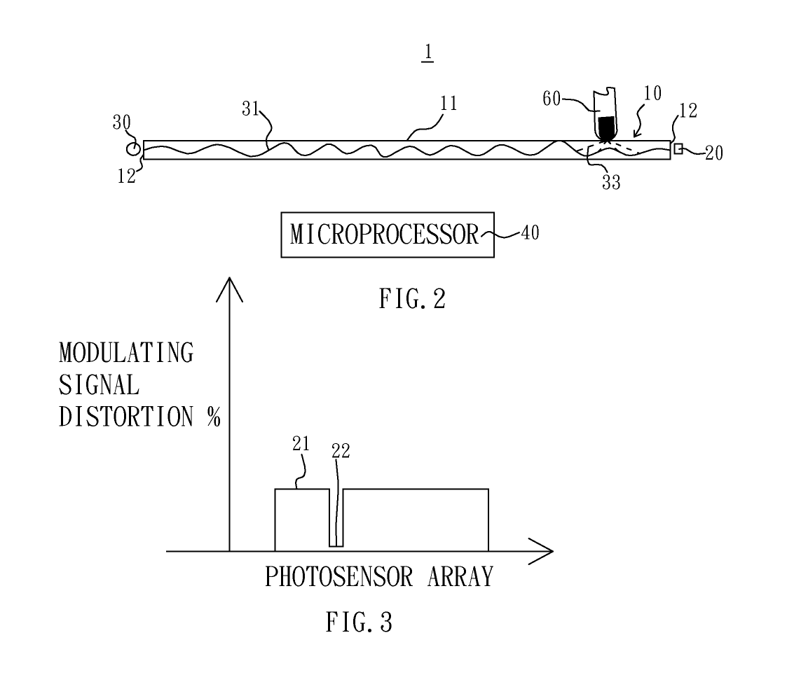

Referring to FIGS. 1 and 2, the first embodiment of the light guide plate touch device 1 according to the present invention comprises a light guide plate 10, a plurality of photosensors, at least two light sources 30, and a microprocessor 40. The light guide plate 10 is a flexible or inflexible plate made of guiding light material such as acrylic plate, resin plate or glass plate. The photosensors 20 can be photodiodes or any other photo sensing components. The light sources 30 can be light emitting diodes (LEDs) or Laser.

The light guide plate 10 has an upper surface 11 and a periphery surface 12. The periphery surface 12 is on the lateral sides of the light guide plate 10. The photosensors 20 and the two of the light sources 30 are electrically connected to microprocessor 40.

The photosensors 20 and the two light sources 30 are arranged at the periphery surface of the light guide plate 10 to surround a region of the light guide plate 10 and forms an operation zone 50.

The two light sources 30 shown in FIGS. 1 and 2 emit lights 31, 32 containing modulating signals to irradiate the guide light plate 10, and the lights 31, 32 propagate in the guide light plate 10 (only light 31 shown in FIG. 2) to shoot the photosensors 20, respectively. The modulating signals are capable of modulating frequency, amplitude or phase of the lights 31, 32.

The photosensors 20 can sense the modulating signals, and the modulating signals sensed by the respective photosensors 20 is normal when the operation zone 50 on the upper surface 11 of the light guide plate 10 is not touched by any objects.

When an object 60, such as a finger, touches the upper surface 11 of the guide light plate 10 within the operation zone 50 to perform an operation of control as shown in FIG. 2, the light 31 emitting from one of the light sources 30 is reflected by the object 60 to become a light 33 which breaks the total reflection so as to change or break the modulating signal propagating to the photosensors 20 with the light 31 such that the modulating signals sensed by the photosensors 20 become distorted modulating signals. The microprocessor 40 is capable of figuring out distortion percentages of the distorted modulating signals with respect to the normal modulating signals as shown in FIG. 3. Most of the modulating signals are normal with a distortion percentage value designated by a reference number 21, and less modulating signals are distorted with a distortion percentage value designated by a reference number 22; the distortion percentage of each modulating signal corresponds to each of the photosensors 20.

The microprocessor 40 detects the modulating signals received by the respective photosensors 20, compares the modulating signals to verify the major normal modulating signals and the minor distorted modulating signals, and confirms that the photosensors 20 which receive the distorted modulating signals have been sensed. Alternatively, the microprocessor 40 figures out the distortion percentages of the modulating signals corresponding to the respective photosensors 20, and confirms that the modulating signals sensed by the photosensors 20 are distorted modulating signals.

One of the light sources 30, the light 31 emitting from the one of the light sources 30, and one of the photosensors 20 sensing a distorted modulating signal can be seen in FIG. 1, wherein a line L1 connecting the one of the light sources 30 and the one of the photosensors 20 can be obtained. Besides, another one of the light sources 30, a light 32 emitting from said another light source 30, and another one of the photosensors 20 sensing another distorted modulating signal can be seen in FIG. 1 as well, wherein another line L2 connecting said another light source 30 and said another photosensors 20 can be obtained. The intersection of the line L1 and the line L2 is a touch point P at which the object 60 contacts the guide light plate 10.

Further, it can be seen in FIG. 1 that the two light sources 30 and the touch point P constitute a triangle, and a length of a connecting line S between the two light sources 30, an angle θ1 between the connecting line S and the line L1. and an angle θ2 between the connecting line S and the line L2 can be figured out with formula provided in Trigonometry for finding out coordinates of the touch point P. The angle θ1 and θ2 are corresponding to positions of the two photosensors 20 sensing the distorted modulating signals and a position of the connecting line S between the two light sources 30, respectively. Hence, position information of the touch point P can be figured out and a corresponding touch signal can be output by the microprocessor 40 according to the following: the microprocessor 40 confirming the photosensors 20 receiving the distorted modulating signals; as well as position information of the two light sources 30 and position information of the two photosensors 20, which correspond to the lights containing the modulating signals sequentially emitting from the two light sources 30 and sense the distorted modulating signals.

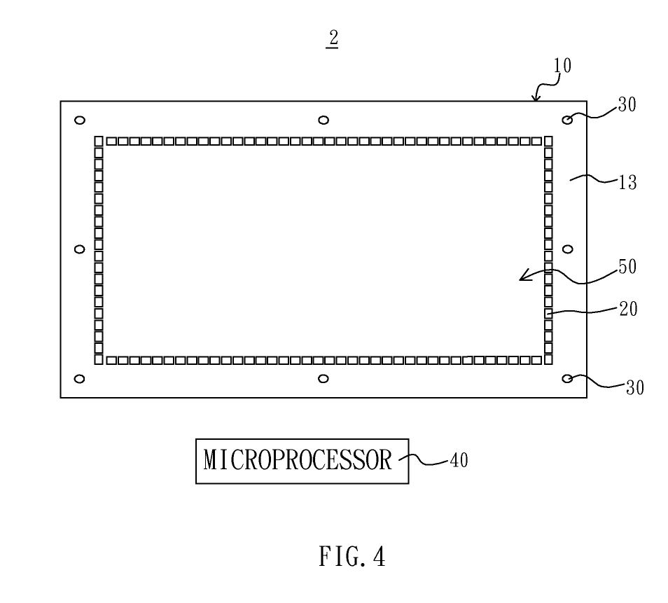

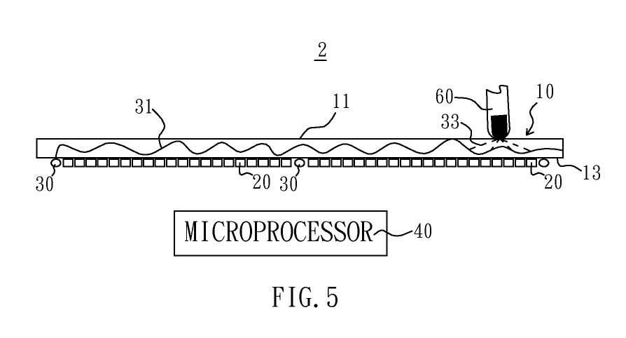

Referring to FIGS. 4 and 5, the second embodiment of the light guide plate touch device 2 according to the present invention comprises a light guide plate 10, a plurality of photosensors 20, at least two light sources 30, and a microprocessor 40.

The light guide plate 10 has an upper surface 11 and a lower surface 13. The photosensors 20 and the two light sources 30 are electrically connected to the microprocessor 40.

The photosensors 20 and the two light sources 30 in the present embodiment are arranged at the lower surfaces 13 of the guide light plate 10, and a region is surrounded by the photosensors 20 to constitute an operation zone 50.

The position information of the touch point P of the second embodiment being figured out and outputting a corresponding touch signal with the microprocessor according to the position information of the two light sources 30 and position information of the two photosensors 20, which correspond to the lights sequentially emitting from the two light sources 30 and sense the distorted modulating signals in the same manner as in the first embodiment except the photosensors 20 and the two light sources 30 being arranged at the lower surface 13 of the light guide plate 10 instead of being arranged at the periphery of the light guide plate 10. No details will be described further.

It is appreciated that the light guide plate touch device according to the present invention provides a plurality of photosensors to surround a region at the lower surface or the periphery of the light guide plate to form an operation zone; when at least two light sources emit lights containing modulating signals sequentially to irradiate the light guide plate, the lights are capable of propagating in the light guide plate to shoot the photosensors, and it results in the photosensors sensing the modulating signals; The position information of the touch point P can be figured out and a corresponding touch signal can be output by the microprocessor using the following information: the microprocessor's confirmation that the photosensors received the distorted modulating signals; the position information of the two light sources; and position information of the two photosensors which correspond to the lights containing the modulating signals sequentially emitting from the two light sources and sense the distorted modulating signals.

The cheap photosensors with at least two light sources utilized by the light guide plate touch device according to the present invention to surround a region of the periphery or at the lower surface of the light guide plate can obtain an effect of sensing the touch point without a capacitive induction layer or metal connecting structure precisely being adhered at the lower surface of the light guide plate. Therefore, the touch device is simplified in structure and lower in cost such that the production yields are enhanced to improve the conventional glass touch device.

Although the invention has been described in relation to its preferred embodiments, it is to be understood that many other possible modifications and variations can be made without departing from the spirit and scope of the invention as hereinafter claimed.

What is claimed is:

1. A light guide plate touch device, comprising:
a light guide plate having an upper surface, a lower surface, and a periphery surface, wherein the upper surface has an operation zone capable of being contacted with a touch point of an object;
at least two light sources sequentially emitting lights containing modulating signals to irradiate the light guide plate;
a plurality of photosensors capable of sensing the modulating signals;
a microprocessor electrically connecting with the light sources and the photosensors, respectively;
wherein the photosensors and said light sources are arranged at the lower surface of the light guide plate only or at the periphery surface of the guide light plate only to surround the operation zone; the lights of said light sources propagate in the light guide plate to shoot the photosensors and the photosensors sense the modulating signals containing the lights; the microprocessor figures out position information of the touch point and outputs a corresponding touch signal according to following: the microprocessor confirming that the modulating signals sensed by the photosensors are distorted modulating signals, position information of said light sources, and position information of at least two of the photosensors corresponding to the two lights and sensing the distorted modulating signals.

2. The light guide plate touch device as defined in claim 1, wherein the light guide plate is a flexible or inflexible plate made of guiding light material.

3. The light guide plate touch device as defined in claim 1, wherein the light guide plate is a glass plate.

4. The light guide plate touch device as defined in claims 1, wherein the photosensors are photodiodes.

5. The light guide plate touch device as defined in claims 2, wherein the photosensors are photodiodes.

6. The light guide plate touch device as defined in claims 3, wherein the photosensors are photodiodes.

7. The light guide plate touch device as defined in claim 1, wherein the light sources are LEDs or Lasers.

8. The light guide plate touch device as defined in claim 2, wherein the light sources are LEDs or Lasers.

9. The light guide plate touch device as defined in claim 3, wherein the light sources are LEDs or Lasers.

10. The light guide plate touch device as defined in claim 4, wherein the light sources are LEDs or Lasers.

11. The light guide plate touch device as defined in claim 4, wherein the microprocessor calculates distortion percentage of the respective modulating signal of each of the photosensors; the microprocessor confirms the photosensors sensing the distorted modulating signals according to the distortion percentage of the respective modulating signal.

12. The light guide plate touch device as defined in claim 5, wherein the microprocessor calculates distortion percentage of the respective modulating signal of each of the photosensors; the microprocessor confirms the photosensors sensing the distorted modulating signals according to the distortion percentage of the respective modulating signal.

13. The light guide plate touch device as defined in claim 6, wherein the microprocessor calculates distortion percentage of the respective modulating signal of each of the photosensors; the microprocessor confirms the photosensors sensing the distorted modulating signals according to the distortion percentage of the respective modulating signal.

14. The light guide plate touch device as defined in claim 7, wherein the microprocessor calculates distortion percentage of the respective modulating signal of each of the photosensors; the microprocessor confirms the photosensors sensing the distorted modulating signals according to the distortion percentage of the respective modulating signal.

15. The light guide plate touch device as defined in claim 8, wherein the microprocessor calculates distortion percentage of the respective modulating signal of each of the photosensors; the microprocessor confirms the photosensors sensing the distorted modulating signals according to the distortion percentage of the respective modulating signal.

16. The light guide plate touch device as defined in claim 9, wherein the microprocessor calculates distortion percentage of the respective modulating signal of each of the photosensors; the microprocessor confirms the photosensors sensing the distorted modulating signals according to the distortion percentage of the respective modulating signal.

17. The light guide plate touch device as defined in claim 10, wherein the microprocessor calculates distortion percentage of the respective modulating signal of each of the photosensors; the microprocessor confirms the photosensors sensing the distorted modulating signals according to the distortion percentage of the respective modulating signal.
